(19) United States
(12) Patent Application Publication
(10) Pub. No.: US 2025/0120409 A1
(43) Pub. Date: Apr. 17, 2025

(54) SYSTEM AND METHOD TO COMPRESS FOOD PRODUCTS BEFORE PACKAGING

(71) Applicant: DANFOTECH INC., Elk Grove Village, IL (US)

(72) Inventor: John W. LILHOLT, Aalborg SØ (DK)

(21) Appl. No.: 18/915,577

(22) Filed: Oct. 15, 2024

Related U.S. Application Data
(60) Provisional application No. 63/544,342, filed on Oct. 16, 2023.

(51) Int. Cl. A22C 7/00; B65B 25/06

(52) U.S. Cl. CPC A22C 7/0023; B65B 25/065

(57) ABSTRACT

A method of pressing a plurality of food pieces into a block of compressed food is provided. The method includes transporting a plurality of pieces of food to a plenum, the plenum with a movable piston and compression chamber. Upon the movement of a first portion of the food pieces into the plenum, moving a closure to a first position that prevents further movement of pieces of food from the scale to the plenum, then moving the piston against the pieces of food toward the compression chamber. The closure and piston are withdrawn from the extended positions and additional food is moved into the plenum, and again moving the closure and the piston, the piston toward and into the compression chamber. After all pieces of food have been urged toward the compression chamber, removing the compressed food from the compression chamber.

### CROSS-REFERENCE TO RELATED APPLICATIONS

This application claims priority from U.S. Provisional Application No. 63/544,342, filed on Oct. 16, 2023, the entirety of which is hereby incorporated by reference herein.

### BACKGROUND OF THE INVENTION

This application relates to machines to press food portions into blocks that are suitable for packaging, shipment, storage for other purposes.

### SUMMARY OF THE INVENTION

A first representative embodiment of the disclosure includes a method of pressing a plurality of food pieces into a block of compressed food. The method includes transporting a plurality of pieces of food to a scale and adding pieces of food to the scale until a measured weight of the food results in a desired weight, facilitating movement, incrementally, the received pieces of food from the scale to a plenum, the plenum includes a movable piston and compression chamber. Upon the movement of a first portion of the food pieces into the plenum, moving a closure to a first position that prevents further movement of pieces of food from the scale to the plenum. After the closure is moved to the first position that prevents further movement of pieces of food from the scale to the plenum, moving the piston against the pieces of food within the plenum toward the compression chamber. The method further includes moving the closure to a second position to allow further movement of pieces of food from the scale to the plenum, and again moving the closure to the first position and again moving the piston against the pieces of food within the plenum toward the compression chamber. After all pieces of food that established the desired weight have moved into the plenum and have been urged toward the compression chamber, removing the compressed food from the compression chamber.

Another representative embodiment of the disclosure includes a method of packaging a block of compressed food. The method includes receiving a plurality of pieces of food and facilitating movement, incrementally, of the received pieces of food to a plenum, the plenum includes a movable piston and compression chamber. The compression chamber includes fixed top, right, left, and bottom walls, and a movable wall that can be positioned between a first position where the movable wall is adjacent to top, right, left, and bottom walls and a second position where the movable wall is withdrawn from the top, right, left, and bottom walls. Upon the movement of a first portion of the food pieces into the plenum, moving a closure to a first position that prevents further movement of pieces of food into the plenum. After the closure is moved to the position that prevents further movement of pieces of food into the plenum, moving the piston against the pieces of food within the plenum toward the compression chamber. The method additionally includes moving the movable wall to the first position before a first time that the closure is moved to the first position and maintaining the movable wall in the first position until all pieces of food that established the desired weight have been urged toward the compression chamber, and moving the closure to a second position to allow further movement of pieces to the plenum, and again moving the closure to the first position and again moving the piston against the pieces of food within the plenum toward the compression chamber. After all pieces of food that established a desired weight have been urged into the compression chamber, moving the movable wall to the second position to allow for the step of removing the compressed food item from the compression chamber and moving the compressed food from an exit aperture in the compression chamber, wherein when the movable wall is in the first position the movable wall blocks movement from the compression chamber through the exit aperture.

Yet another embodiment of the disclosure is provided the embodiment includes an apparatus for packing a block of compressed food. The apparatus includes a plenum disposed to intermittently receive a plurality of pieces of food therein, the plenum comprising a movable piston and a movable closure disposed upon the plenum and with respect to an upper opening into the plenum, wherein the closure is movable between a first position where food is able to move into the plenum through the upper opening and a second position that prevents food from moving into the plenum through the upper opening. The plenum further comprises a receipt location and a compression chamber, wherein when the piston moves from a first position toward a second position, the pieces of food that fall through the opening are disposed within the receipt location, as the piston moves from the first position toward the second position the piston engages the pieces of food disposed within the receipt location and urges the pieces of food into the compression chamber as the piston moves toward and reaches the second position. The compression chamber includes a movable wall at an end thereof, and fixed remaining walls the movable wall is movable between a pressing position where the movable wall is proximate the remaining walls and a withdrawn position where the movable wall is withdrawn away from the remaining walls, wherein when the movable wall is in the pressing position, the movement of the piston toward and reaching the second position causes the food within the compression chamber to be compressed within a space defined by a front face of the head of the piston, the movable wall and the fixed remaining walls, the plurality of pieces of food are compressed within the compression chamber into a single block of food. The plenum includes an exit aperture that is covered when the movable wall is in the pressing position and exposed when the movable wall is in the withdrawn position, the space is shaped consistently with a shape of a package that will receive the single block of food, wherein the block of food leaves the plenum through the exit aperture.

Advantages of the present disclosure will become more apparent to those skilled in the art from the following description of the preferred embodiments of the disclosure that have been shown and described by way of illustration. As will be realized, the disclosed subject matter is capable of other and different embodiments, and its details are capable of modification in various respects. Accordingly, the drawings and description are to be regarded as illustrative in nature and not as restrictive.

### BRIEF DESCRIPTION OF DRAWINGS

FIG. 1 is a perspective view of the housing of system for compressing a plurality of pieces of food into a block that is ready to be packaged.

FIG. 1a is another view of the housing with several doors of the housing opened to depict the components within the housing.

FIG. 2 is a perspective view that schematically depicts a scale and a packaging apparatus along with the housing of FIG. 1.

FIG. 3 is a perspective view of the plenum and piston assembly of the system of FIG. 1.

FIG. 4 is a perspective cross-sectional view of the housing of FIG. 1 with the piston, the closure, and the movable wall each in the withdrawn positions.

FIG. 5 is the view of FIG. 4 with the closure in the extended position.

FIG. 6 is the view of FIG. 4 with the closure in the extended position, the piston in the extended position, and the movable wall in the engaged position, with food pieces schematically depicted being compressed within the compressing chamber of the housing.

FIG. 7 is another view of the plenum of the housing with the lower wall removed and depicting a conveyor disposed in-line with a position of the lower wall if it would be shown, such that the a compressed food block rests upon the conveyor and operation of the conveyor urges the food block out of the housing through the aperture in the rear wall.

FIG. 8 is the view of an embodiment of the housing of FIG. 1, wherein the piston is extended pas the extended position to an exit position, where the movement of the piston from the extended position to the exit position urges the compressed block of food out of the housing through the aperture in the rear wall.

### DETAILED DESCRIPTION OF THE INVENTION

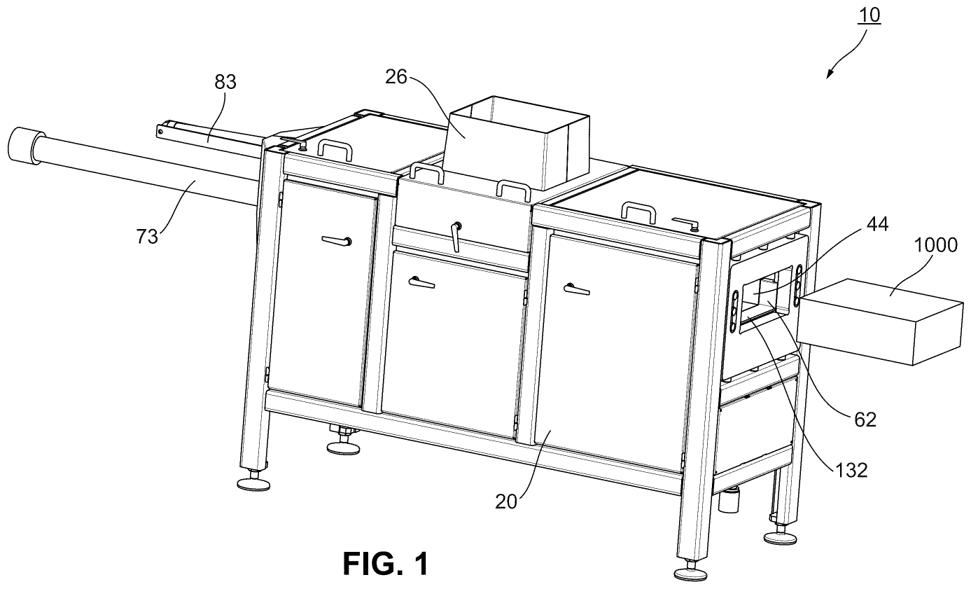

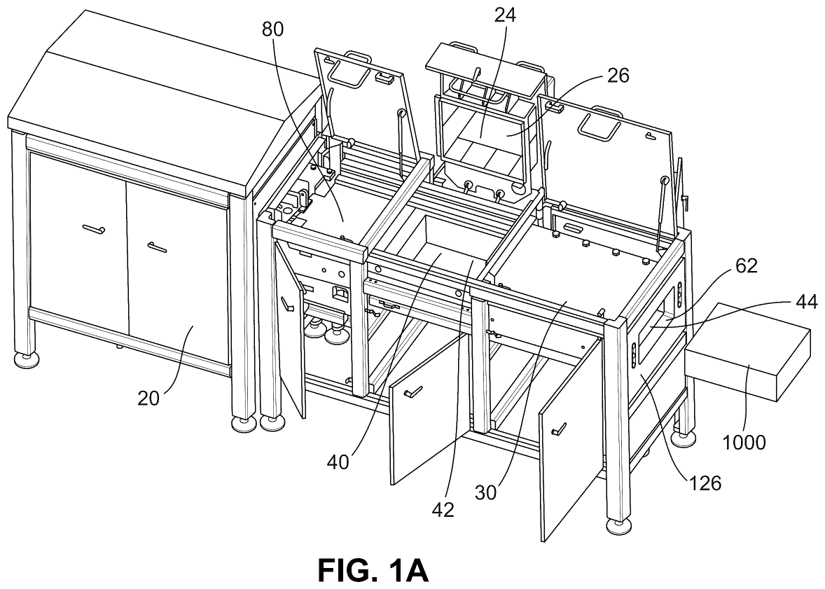

Turning now to FIGS. 1-8, a system 10 for compressing a plurality of pieces of food, such as frozen food pieces. A method for compressing a plurality of food pieces into a block of compressed food is also provided. The system and methods discussed herein are discussed with specificity regarding use with frozen meat pieces (such as beef, chicken, pork, or the like), but the system and methods can also be used with other types of foods in pieces, such as cheese, bread, vegetables, carbohydrates, among others. While for the sake of brevity, the system is discussed herein for receipt of frozen pieces of meat, one of ordinary skill in the art with a thorough review and understanding of this specification will readily understand how the system and method may be used for other particles of food. The system and method are described herein specifically for use with frozen food pieces (either completely frozen or partially frozen) but the system and method may be used for food pieces that are received in other conditions, such as cold, room temperature, hydrated, dehydrated, and the like. In some embodiments, the food pieces may be pieces of uniform size, shape, and/weight, while in other embodiments the food pieces may be non-uniform of one, two or all of size shape and weight. Any modifications for the system and method that would be necessary or preferred when used with food other than frozen pieces is discussed herein.

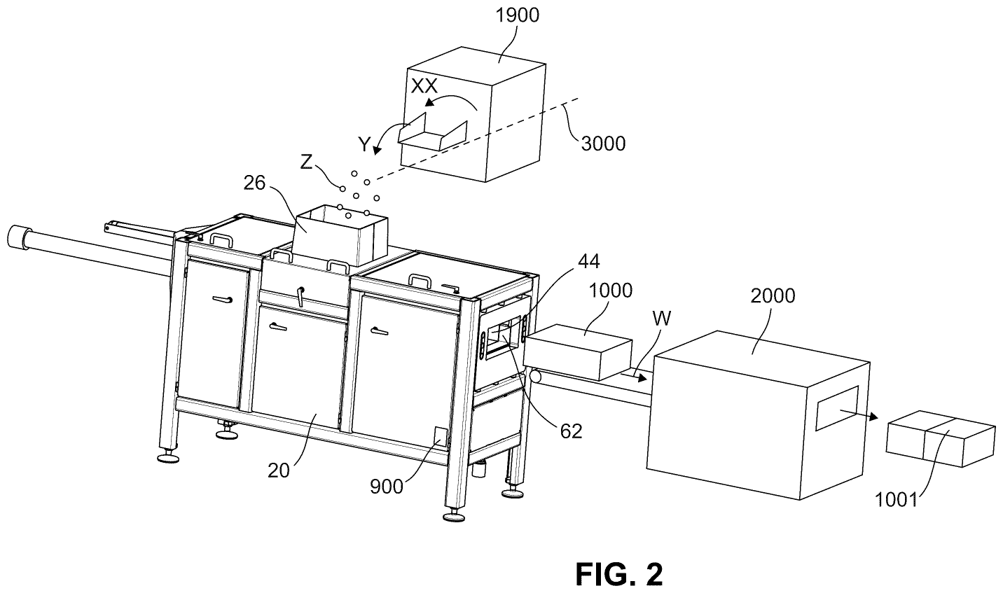

The operation of the components of the system 10, may be coordinated or instructed by a controller 900 (FIG. 2, schematic). The controller 900 may be a microprocessor control system of which are known by those of ordinary skill in the art. The controller 900 may be programmed with instructions for operating the various components of the system based upon one or more sensed parameters (as discussed herein), as well as based upon fixed operational instructions. The controller may control the operation of, including the timing of operation, of one or more of the piston 70, the closure 80, the movable wall 120. The controller 900 may also directly control one or both of the scale 1900 and/or the packaging machine 2000, or in the event that the controller 900 does not control the scale 1900 and/or the packaging machine—the controller 900 is in communication with these mechanisms such that the system 10 is properly operated based upon status updates or informational signals received from controllers (not shown if not included within 9000) that are associated with the scale 1900 and the packaging machine 2000.

With reference to FIG. 1 the system 10 includes a pressing component 20 that is provided for pressing pieces of food Z into a single form, such as a block that includes many pieces of food that are pressed together. The block 1000 (schematic) is formed into a shape that mirrors the geometry and size of a compression chamber 44. The block 1000 upon formation may leave the pressing component 20 may be further processed for use or for storage, or shipment to customers. The block 100 is preferably shaped within the compression chamber 44 (as discussed below) such that when it leaves the pressing component 20 it is in the exact shape of the box or packaging that will receive the food block 1000—to allow for convenient storage, shipment to other uses. The system and method are configured to allow for pressing food directly into a size and shape that is configured to be directly packed within the desired packaging, and to receive a volume of food pieces that are weighed or otherwise evaluated to include exactly the amount of (size, weight) of food pieces that are desired for sale within the desired packaging. To date, there has not been a pressing solution that is configured for and capable of working with this functionality. The term “exactly” is defined herein to mean the exact same amount as well as a tolerance for the amount that is conventional within the industry, such as within a range of plus or minus 1%, 2% or 5% from the target amount inclusive of all percentages between the end of the tolerance percent and the target amount.

The pressing component 20 includes a housing 22 that rigidly supports the portions of the pressing component. The pressing component 20 may be used as a stand-alone system, or it can be used directly and as a single unit with a scale 1900 (as discussed herein) and with a packaging machine 2000. The housing 22 supports a plenum 40, a movable piston 70 and a closing plate 80 therein. The housing may additionally support a funnel 26 that directs food pieces into the plenum 40 from above. The housing further supports a moving end wall 120 that can be moved from a withdrawn position to allow compressed food blocks 1000 to exit the housing 22 via an aperture 62, and to an engaged position to prevent food blocks 1000 (or anything else) from extending through the aperture 62. When in the engaged position the end wall 120 aligns with the fixed walls within the compression chamber 44 within the plenum 40 (discussed below). The housing 22 may further support or be constructed with a scale (FIG. 2, schematic) and/or a packaging machine 2000 (FIG. 2, schematic).

The scale 1900 may be a device that continuously receives a feed of frozen food pieces and weighs the increasing amount until the weight totals a predetermined desired amount. Upon receipt of the predetermined desired amount, the scale 1900 temporarily discontinues receiving further food pieces. In this embodiment, the scale 1900 is positioned upon or with respect to the housing 22 such that the scale 1900, when it receives the predetermined desired amount of food pieces, and when the plenum 40 is ready to receive a new quantity of food pieces therein for forming a new block (i.e. when a previously quantity of food pieces Z has been pressed and removed from the plenum 40, and the piston 70 is in the withdrawn position)), causes a portion (i.e. a batch) of the entire volume of food within the scale 1900 to transition into the plenum 40. The system 10 then operates to compress the food pieces Z as discussed herein. After an initial compression, the piston 70 may be again withdrawn, and the scale causes another batch of the entire volume of food to transition into the plenum 40. In some circumstances, all of the food pieces may transition into the plenum 40 in one instance, while in other circumstances, the food pieces Z may be transitioned into the plenum 40 (and pressed by the system 10 as discussed below) in a groupwise manner with a batch (i.e. a portion) of the entirety being transitioned into the plenum 40 with each cycle. In some embodiments, all of the food pieces Z may be transitioned from the scale into the plenum with two batches, three batches, or additional batches.

The food pieces Z may transition from the scale 1900 into the plenum 40 using different structures. In one embodiment, the scale 1900 may be positioned vertically above and aligned with the opening 24 into the plenum 40, and the scale 1900 may rotate (XX, FIG. 2, schematic) about a horizontal axis 3000 to allow some of the food pieces Z to fall out Y of the scale as it rotates (FIG. 2), with the food pieces falling through a funnel 26 upon the housing 20 and the opening 24 into the plenum 40 when the scale 1900 is rotated. In other embodiments, the scale 1900 may be positioned above and aligned with the opening 24 into the plenum such that a portion of the food pieces within the scale may be pulled or dragged, or carried, out of the scale and then either placed through the opening 24 or allowed to fall from the scale into the opening. In still further embodiments, food pieces within the scale may be scooped up from the scale 1900 by an arm or robotic mechanism with the scooped up food pieces Z dropped through the opening or placed through the opening in the plenum 40. The food pieces Z may be transitioned from the scale 1900 and ultimately into the plenum 40 using one of the these structures in a groupwise manner via two or several batches such that with several iterations a percentage (such as an equal percentage at least for the batches other than the last batch which might include a residual amount that is less than the equal percentage of the previous batches) of the food pieces transition from the scale 1900 and into the plenum 40.

The scale 2000 may incrementally receive food pieces that are transported to the scale 2000 either continuously or via a plurality of batches that are individually transported to the scale in an iterative fashion until a measured weight of the collective food pieces Z within the scale results in the desired weight. In some embodiments, each batch is transported and weighted individually such that the amount of the transported food that reaches the scale is exactly the desired weight.

The packaging machine 2000 is a machine that is configured to receive a volume of food (in this circumstance a block 100 of compressed frozen food pieces) and prepare or assemble packaging 1001 around that block of food for future use, storage, shipment or the like. In some embodiments, the packaging machine 2000 is configured to place the food block 1000, or manipulate the block such that it is place, within a package, which maybe a box (such a corrugated cardboard, or the like), a bag such as clear flexible plastic, or a combination of the two and/or with other types of conventional packaging that are known in the art to store food items for future use, shipment, freezing or other storage. In some embodiments, the packaging machine 2000 is configured to manipulate the food block 1000 such that it is inserted into a box that is the same size and shape as the food block (specifically the storage volume is has a just larger size and shape as the food block) so that the food block 1000 fits therewith with minimal excess open volume. The food block may, before being placed within the box be placed within a plastic wrap to prevent leakage of the food into the box itself, such as if the food block is no longer fully frozen within the box, or prevent contamination of the food block 1000 from outside influences, or for food safety reasons or other purposes. In some embodiments, the packaging machine 2000 may place the food block within the box (and potentially plastic wrap/bag) through an opening into the box and then close the box, or alternatively the machine may place the food block (with plastic wrap/bag) and fold/form the box around the food block to result in a sealed box. In some embodiments multiple food blocks 1000 may be placed within a single box, and potentially a single wrap/bag or multiple individual wraps/bags). The packaging machine 2000 is configured to form a package 1001 that is with a consistent size for receipt of a block of a consistent weight as prepared by the system 10.

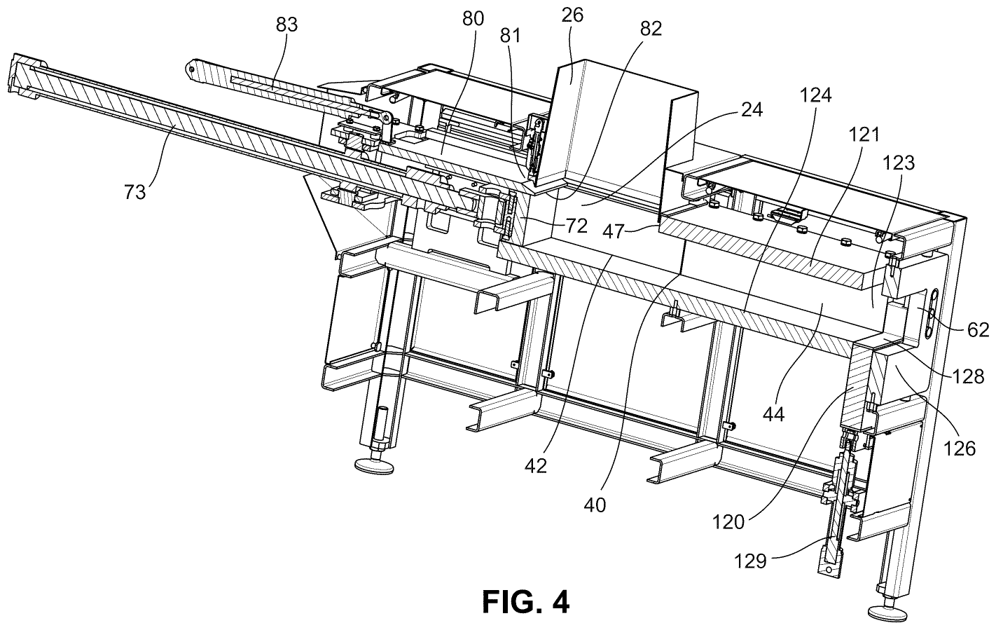

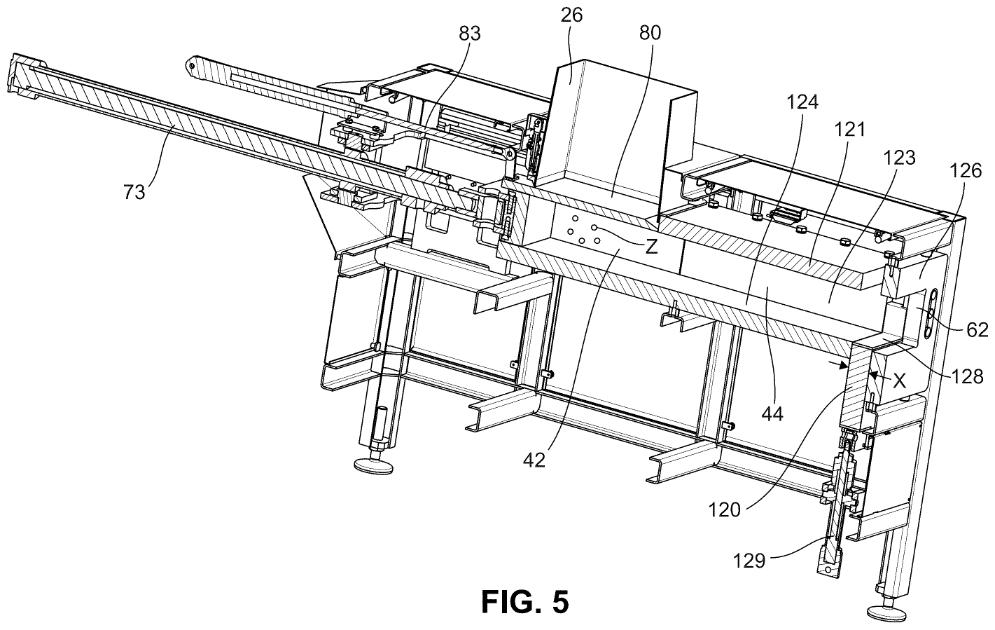

The plenum 40 is best shown in FIGS. 4-8. The plenum 40 includes a receipt portion 42 and a compression chamber 44. The plenum 40 includes an opening 41 that is above the entire, or a portion of the receipt portion 42, through which food enters into the receipt portion. The receipt portion 42 and the compression chamber 44 are adjacent to each other such that food pieces that are pushed from the receipt portion 42 by the piston 70 as the piston moves from a retracted position FIG. 4 (first position) to an extended position (FIG. 5-7) wherein the head 82 of the piston 80 in combination with the fixed walls (discussed below) and the moving end wall 120 forms the food pieces therebetween into a desired shape for packaging (discussed above).

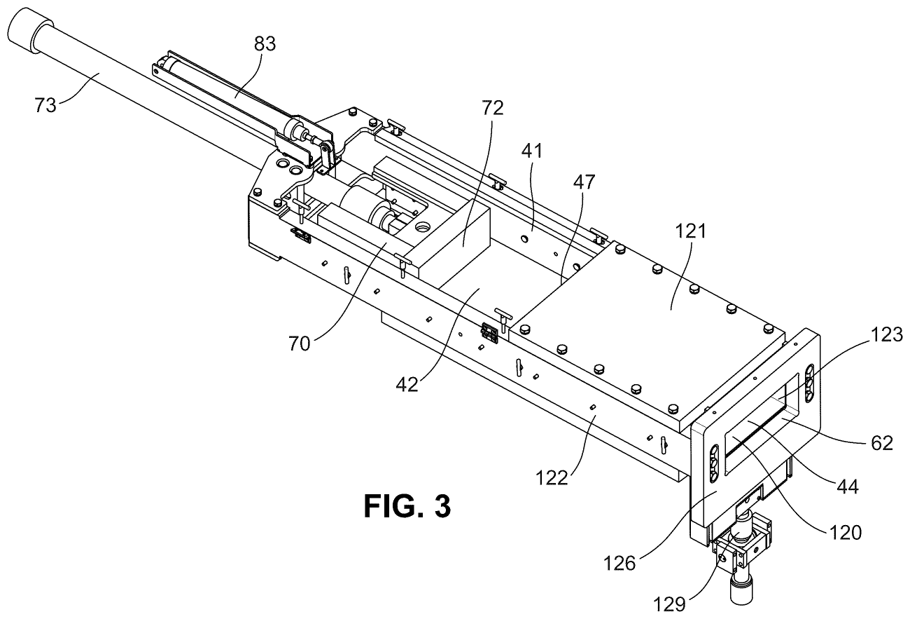

The compression chamber 44 is best understood with review of FIGS. 3-6. The compression chamber 44 includes a top wall 121, a right wall 122, a left wall 123 (similar to and opposing the right wall), and a floor 124. The compression chamber 44 further includes an outlet wall 126 that includes an aperture 62 that is sized and shaped to be just larger than the largest planar vertical cross-section of the food block 1000 that is formed within the compression chamber 44.

In some embodiments, each of the top wall 121, the right wall 122, the left wall, and the floor 124 are planar along their entire surface that faces into the compression chamber 44, such that the food block 1000 that is formed therein has planar sides that are formed by the existence of these walls. In other embodiments, one or more of the top wall 121, the right wall 122, the left wall 123, and the floor 124 may have a non-planar orientation that faces into the compression chamber. In these embodiments one or more of these surface may have an arcuate surface (such as one that is concave downward to form a convex shape upon the food block by the concave shape of the wall, or a convex surface to form a similar concave shape of the food block, or a more arbitrary arcuate, or partially arcuate partially planar face), or the surface may be formed of two or more planes that are disposed at angles to each other to define one or more edges. Preferably, the profile of each wall is consistent along its length (i.e. the direction parallel to the direction of travel of the piston 70 between the retracted and engaged positions) such that the vertical cross section of the formed food block is consistent along its length to allow the food block to travel through the aperture 62 in the outlet wall 126 that is in the same shape as the cross-section of the food block 1000 and only slightly larger than the food block 1000. The aperture 62 in the figures is shown as rectangular, but one of ordinary skill in the art with a thorough review of this specification will readily comprehend that the aperture 62 may be any shape through which the formed food block 1000 can extend, such the same shape (but somewhat bigger) than the vertical cross-sectional shape of the food block 1000.

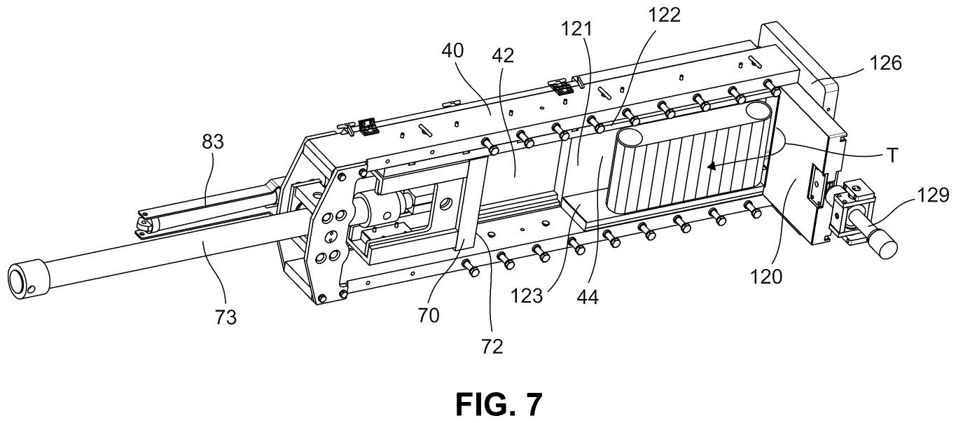

In some embodiments, the floor 124 may be a rigid surface. In some embodiments, a portion of the floor 124 proximate to the outlet wall 126 (but spaced from the outlet wall by a gap X (FIG. 5) that is slightly wider than the width of the moving end wall 120). The floor 124 in some embodiments may have a portion (or an entirety of the length of the floor 124 within the compression chamber 44 that is formed by a conveyor 99 (FIG. 7, schematic, movable in direction T) such that after the piston 70 has moved to the compression position to form the food block 1000, the conveyor 99 may operate to move the food block 1000 (moving direction T of the conveyor 99) out of the compression chamber 44 through the aperture 62. In some embodiments, when the movable wall 120 is fully withdrawn from the compression chamber 44, the end face 128 of the wall 120 is flush with the wall/floor 124 that includes the gap X, such that the food block 1000 when moving out of the aperture 62 moves across the extended end 129 of the wall 120. The movable wall 120 is depicted in the figures as extending through a gap X in the floor 124, but in other embodiments, the movable wall 120 may disposed such that it extends through a gap in the right or left side walls 122, 123, or the top wall 121 if the movable wall 120 was differently positioned within the housing 20 as discussed below.

In some embodiments, each of the top wall 121, the right wall 122, the left wall 123, and the floor 124 are fixed walls, and the only movable wall that directly imparts pressure onto the food pieces therein (to form the food block 1000) is the piston 70. As can be understood, as the piston 70 pushes against the food pieces Z within the compression chamber 44, the length compression chamber 44 decreases, which urges the food pieces against each other and outwardly such that they contact and push against the top wall 121, right wall 122, left wall 123, floor 124, and the movable wall 120, and the fixed nature of these walls applies a reaction force against the food block 1000 to set the food block into the geometry established within the compression chamber 44. In other embodiments, one of the top wall 121 or the right or left walls 122, 123 may be a movable wall that can move inwardly and outwardly to expand or reduce the geometry of the compression chamber 44, which would work in conjunction with the piston 70 to press upon the food pieces within the compression chamber 44 to form the block. The movement of the wall other than the piston 70, when provided, may be simultaneous with the movement of the piston 70 in the pressing direction, or sequentially to move to reduce the volume of the compression chamber 44 after the piston 70 has completed its travel.

The movable wall 120 is best shown in FIGS. 3-7. The movable wall 120 may move vertically as depicted in the figures such that when in a withdrawn position (which exposes the aperture 62 in the outlet wall 126 to allow the food block 1000 to move therethrough) the movable wall is disposed below the surface of the floor 124 that contacts the food pieces/food block 1000 within the compression chamber 44. When the movable wall 120 moves toward the compression chamber (the closed position) it is within the compression chamber 44 to block the aperture 62 and be engaged by the food pieces to define a face of the food block 1000 during the compression process. In other embodiments, the movable 120 wall may be withdrawn out of the compression chamber by vertical movement in an upward direction from the compression chamber (instead of the vertical movement in the downward direction as depicted in the figures). Still alternatively, the movable wall 120 may be withdrawn from the compression chamber 44 in the left direction or the right direction to withdraw the movable wall from the compression chamber 44 to expose the aperture 62—based upon the design intent of where in the housing 20 the mechanism to operate the movable wall 120 is desired to be placed. The movable wall 120 may be moved based upon any structure that is known in the art that can cause longitudinal motion of the movable wall 120 between the inserted position (within the compression chamber 44 blocking the aperture 62 and aligned to be contacted by the food pieces to establish the food block) and the withdrawn position, such as a linear actuator 129, a belt drive, a gear train, a linear motor, a pneumatic or hydraulic system or the like.

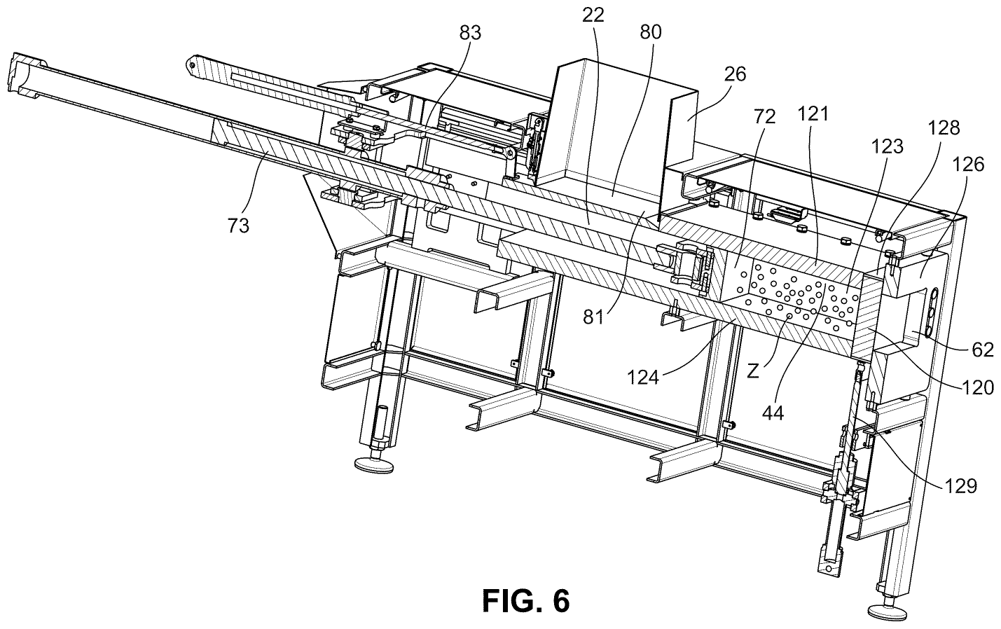

The piston 70 is best shown in FIGS. 3-7 and extends between a withdrawn position (FIG. 4) and an extended/compressing position (FIG. 6) (and in some embodiments the exit position as discussed herein). The piston includes a piston head 72 with a face that contacts food pieces Z that are within the plenum 40 and pushes them to the compression chamber 44 and presses the plurality of food pieces Z into the food block 1000 (in combination with the fixed walls and potentially other pressing surfaces as discussed herein). The piston 70 may be moved based upon any structure that is known in the art that can cause longitudinal motion of the piston 70 between the its different position discussed herein, such as a linear actuator 73, a belt drive, a gear train, a linear motor, a pneumatic or hydraulic system or the like.

The closing plate 80 is best shown in FIGS. 3-7. The closing plate 80 is configured with respect to the plenum 40 to move between a withdrawn position (FIG. 4) that is withdrawn from the opening 24 into the plenum 40 to a second position (FIG. 5) where the closing plate 80 extends over the opening 24 to block food pieces from falling into (or otherwise moving into) the plenum 40. The closure 80 may be a flat plate with planar top and bottom side portions that can extend though a rectangular slot in a top wall of the housing that defines a portion of the plenum 40. The closing plate 80 may have a front portion that forms a planar leading face 81 that engages a wall 47 of the housing that forms a top of the plenum 40 between the receipt portion 42 and the compression chamber 44. Alternatively, the front portion may form an edge 82 along the entire width of the front wall or a portion of the width of the front wall 81 that contacts the wall 47 of the housing 20 when in the second position. In some embodiments, the edge 82 may be a sharp edge or a hardened edge that would cut through any food pieces that are disposed between the edge 82 and the wall 47 of the housing as the closing plate 80 moves to the closing position, to avoid the food piece from blocking remaining movement of the closing plate to the second position.

The closing plate 80 may move between the withdrawn position and the second position with any structure that is known in the art to cause linear motion of the closing plate between the two positions, such as a linear actuator 83, a belt drive, a gear train, a linear motor, or the like, a pneumatic or hydraulic system, or the like.

As discussed herein the closing plate 80, the moving end wall 120, and the piston 70 are operated (or caused to operate) by a controller 900 (FIG. 2, schematic), as discussed herein.

The controller 900 is configured to operate the system as follows. Initially, the piston 70 and the closing plate 80 are in the withdrawn positions (FIG. 4) and therefore the opening 24 into the plenum 40 is open to allow food pieces to fall or be positioned through the opening 24 and into the receipt portion 42 of the plenum (and to fall through the funnel 26 disposed within the housing 20 when provided). Once the controller determines that the piston 70 and the closing plate 80 are in the withdrawn position the controller 900 identifies that the system 10 is ready to receive food pieces Z and causes a signal to be sent to the scale 1900 to cause food pieces from the scale to enter into the receipt portion 42 (FIG. 2, Y schematic) as discussed herein.

At this stage the controller 900 causes the end wall 120 to move to the closed position. Alternatively, the controller 900 may wait to cause the end wall 120 to move to the closed position until after a first batch of food pieces has entered the receipt portion 42 of the plenum 40 as discussed below.

When the controller 900 determines that the batch of food pieces has entered into the receipt portion 42, as discussed below and (in some embodiments) has determined that no further food pieces will enter into the receipt portion 42 from the batch, the controller 900 causes the closing plate 80 to move to the closed position thereby blocking the opening 24 into the plenum 40. After the closing plate 80 reaches the closed position, the controller 900 causes the piston 70 to move to the extended position, thereby pushing all of the food pieces that are in the receipt portion 42 toward the compression chamber 44.

In embodiments when multiple batches of food pieces Z from the scale 1900 are caused to be moved into the receipt portion 42 in an iterative fashion, the first batch (and perhaps some or all of the batches until the final batch) may not be compressed by the piston 70 within the compression chamber 44 because the collective volume of the food pieces may be less than the volume of the compression chamber 44 when the piston is in the extended position. In some circumstances, the movement of the piston 70 does cause some compression or re-arrangement of the food pieces in the first batch (and any subsequent batches before the final batch) due to the food pieces being initially pushed by the piston 70 at positions upon or proximate to the floor 124, with the distance between the end face of the piston 70 and the end wall 120 being small enough to prevent the food pieces from all being disposed proximate to the floor when the piston 70 extends proximate to and reaching its fully extended position, which does impart some compression on the food pieces and causes rearrangement of some of the food pieces vertically upward within the compression space 44.

After reaching the fully extended position, the piston 70 may be paused in that position, and then is withdrawn as caused by the controller 900 to return to the withdrawn position. As the piston 70 moves toward the withdrawn position, the closing plate 80 is also moved to the withdrawn position. These two may move simultaneously toward the withdrawn position, or sequentially in either order as desired.

Once the piston 70 and the closing plate 80 have reached the withdrawn positions, the controller may cause another batch of food pieces to fall or be positioned within the receipt portion 42. After the controller 900 determines that this next batch of food pieces has entered into the receipt portion 42 (and in some embodiments that no further food pieces from the batch will enter the receipt portion), the controller 900 causes the closing plate 80 to move to the closed position thereby again blocking the opening 24 into the plenum 40. After the closing plate 80 reaches the closed position, the controller 900 causes the piston 70 to again move to the extended position, thereby pushing all of the food pieces that are in the receipt portion 42 toward the compression chamber 44.

This process occurs until all batches of food pieces have entered into the plenum and been pushed into the compression chamber 44.

After a delay time of with the piston in the extended position within the compression chamber 44, the end wall 120 is moved to the withdrawn position. This step may occur with the piston 70 remaining in the extended position, or alternatively, the piston 70 may move slightly or fully away from the extended position before the end wall 120 is moved.

The end wall 120 movement to the withdrawn position exposes the aperture 62 and allows the now compressed food block 1000 to move through the aperture 62 and out of the housing 20—where it may be packed or further processed as discussed herein.

In embodiments where the floor, or another surface is formed partially or completely from a portion of a conveyor 99, the conveyor 99 operates to move the food block through the aperture 62.

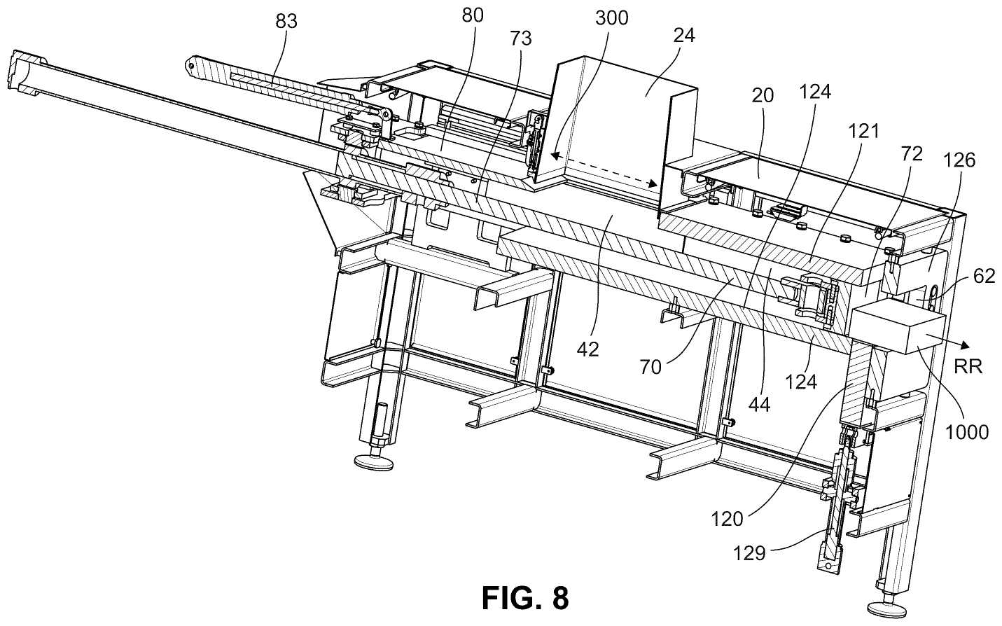

In some embodiments, the piston 70 may have three positions, a withdrawn position (as discussed above), an extended position, and an exit position (FIG. 8). The extended position is similar to the extended position of the piston 70 as discussed in the embodiments discussed above such that the when the piston is in the extended position, and at least when the compression chamber 44 includes all of the volume of food pieces that are desired to be compressed together, the movement of the piston from the withdrawn position to the extended position imparts a force upon the food pieces to, collectively with the other walls within the compression chamber 44, cause the food block 1000 to form from the food pieces Z therein by compression within the compression chamber 44 and be formed with the volume formed by the inner surface of the walls of the compression chamber 44 (including the extended face of the piston 70). When the desired amount of food pieces have been compressed within the compression chamber 44, the end wall 120 may be moved to the withdrawn position, thereby exposing the aperture 62, and the piston 70 may move to the exit position, which is in the same direction of travel as the piston moves from the withdrawn position toward the extended position and past the extended position, with continued movement of the piston toward the exit position pushing the food block 1000 out of the plenum 40 and through the aperture 62.

The operation of the piston 70 when it can be moved to between the withdrawn, extended, and exit positions is similar to the operation of the piston as discussed above, but the ultimate necessary travel of the piston is longer than with the two position piston.

As discussed above, the controller 900 may determine when no further food pieces will enter the receipt portion 900 from the scale 1900 in various methods. For example, the weight of the collective food pieces Z upon the scale 1900 may be continuously measured and the change in weight upon the scale 1900 based upon the removal of each batch may be (at a level that is desired or expected for each different batch to enter into the receipt portion 42) may be monitored, and when the weight change that is expected is sensed the controller would determine that no further food pieces will enter into the plenum 40 for that batch. Alternatively, a motion sensor 300 (FIG. 8, schematic) may be provided that observes the opening and may determine that no further food pieces will enter the receipt portion after a first sensed motion and after no further motion is sensed (and a delay period) after a batch is caused to be moved from the sale and to the plenum 40. The motion sensor 300 may be a laser sensor, an optical sensor, a radar sensor, or other types of sensors that are known to identify motion therepast. Other systems to identify the movement of a certain volume of food pieces as associated with a batch may be provided.

The term “about” is specifically defined herein to include a range that includes the reference value and plus or minus 5% of the reference value. The term “substantially the same” is satisfied when the width of the end surfaces of the holes are both within the above range.

While the preferred embodiments of the disclosed have been described, it should be understood that the invention is not so limited and modifications may be made without departing from the disclosure. The scope of the disclosure is defined by the appended claims, and all devices that come within the meaning of the claims, either literally or by equivalence, are intended to be embraced therein.

The subject specification can be best understood with reference to the following Numbered Paragraphs:

Numbered Paragraph 1: A method of pressing a plurality of food pieces into a block of compressed food, comprising:
transporting a plurality of pieces of food to a scale and adding pieces of food to the scale until a measured weight of the food results is a desired weight;
facilitating movement, incrementally, the received pieces of food from the scale to a plenum, the plenum includes a movable piston and compression chamber,
upon the movement of a first portion of the food pieces into the plenum, moving a closure to a first position that prevents further movement of pieces of food from the scale to the plenum,
after the closure is moved to the first position that prevents further movement of pieces of food from the scale to the plenum, moving the piston against the pieces of food within the plenum toward the compression chamber;
moving the closure to a second position to allow further movement of pieces of food from the scale to the plenum;
again moving the closure to the first position and again moving the piston against the pieces of food within the plenum toward the compression chamber;
after all pieces of food that established the desired weight have moved into the plenum and have been urged toward the compression chamber, removing the compressed food from the compression chamber.

Numbered Paragraph 2: The method of Numbered Paragraph 1, wherein the compression chamber comprises fixed top, right, left, and bottom walls, and a movable wall that can be positioned between a first position where the movable wall is adjacent to top, right, left, and bottom walls and a second position where the movable wall is withdrawn from the top, right, left, and bottom walls,
further comprising the step of moving the movable wall to the first position before a first time that the closure is moved to the first position and maintaining the movable wall in the first position until all pieces of food that established the desired weight have been urged toward the compression chamber;
after all pieces of food that established the desired weight have been urged into the compression chamber, moving the movable wall to the second position to allow for the step of removing the compressed food item from the compression chamber, wherein the compressed food is urged through an exit aperture of the compression chamber.

Numbered Paragraph 3: The method of either one of Numbered Paragraphs 1 or 2, wherein the plurality of pieces are transported to the scale in a plurality of batches that are transported and weighed in an incremental fashion until the measured weight results in the desired weight.

Numbered Paragraph 4: The method of Numbered Paragraph 3, wherein the step of facilitating movement incrementally pieces of food from the scale to the plenum comprises rotating a portion of the scale to allow food from the scale to drop into the plenum due to gravity.

Numbered Paragraph 5: The method of any one of the preceding Numbered Paragraphs, after removing the compressed food item from the compression chamber, packaging the compressed food item within a package of a predetermined size and shape.

Numbered Paragraph 6: The method of either of Numbered Paragraphs 1 or 2, after removing the compressed food from the compression chamber, packaging the compressed food within a package of a predetermined size and shape.

Numbered Paragraph 7: The method of either one of Numbered Paragraphs 1 or 2, after the movable wall is moved to the first position, maintaining the movable wall in the first position until the closure has moved to the second position after all pieces of food that established the desired weight have moved into the plenum and have been urged toward the compression chamber.

Numbered Paragraph 8: The method of any one of the previous Numbered Paragraphs, wherein the plenum comprises a top aperture, the food pieces are received within the plenum by falling through the top aperture, the closure in the first position blocks the top aperture, and in the second position exposes the top aperture.

Numbered Paragraph 9: The method of Numbered Paragraph 8, wherein the piston is withdrawn from the plenum when in a first position, and the piston extends through the plenum as the piston moves toward the compression chamber.

Numbered Paragraph 10: The method of any one of the preceding Numbered Paragraphs, wherein the compression chamber is defined by a planar top wall, a planar right wall, a planar left wall, and a planar bottom wall, wherein the piston includes a head that is sized with a cross section that is just smaller than a cross-section within the compression chamber defined by the planar top wall, the planar right wall, the planar left wall, and the planar bottom wall.

Numbered Paragraph 11: The method of any one of the preceding Numbered Paragraphs, wherein the compression chamber comprises a uniform cross-sectional area from a plane through a head of the piston when the piston is in the second position proximate to the exit aperture of the plenum.

Numbered Paragraph 12: A method of packaging a block of compressed food, comprising:
receiving a plurality of pieces of food;
facilitating movement, incrementally, of the received pieces of food to a plenum, the plenum includes a movable piston and compression chamber,
wherein the compression chamber comprises fixed top, right, left, and bottom walls, and a movable wall that can be positioned between a first position where the movable wall is adjacent to the top, right, left, and bottom walls and a second position where the movable wall is withdrawn from the top, right, left, and bottom walls,
upon the movement of a first portion of the food pieces into the plenum, moving a closure to a first position that prevents further movement of pieces of food into the plenum,
after the closure is moved to the position that prevents further movement of pieces of food into the plenum, moving the piston against the pieces of food within the plenum toward the compression chamber;
moving the movable wall to the first position before a first time that the closure is moved to the first position and maintaining the movable wall in the first position until all pieces of food that established a desired weight have been urged toward the compression chamber;
moving the closure to a second position to allow further movement of pieces to the plenum;
again moving the closure to the first position and again moving the piston against the pieces of food within the plenum toward the compression chamber;
after all pieces of food that established a desired weight have been urged into the compression chamber, moving the movable wall to the second position to allow for the step of removing the compressed food item from the compression chamber and moving the compressed food from an exit aperture in the compression chamber, wherein when the movable wall is in the first position the movable wall blocks movement from the compression chamber through the exit aperture.

Numbered Paragraph 13: The method of Numbered Paragraph 12, after removing the compressed food from the compression chamber, further comprising packaging the compressed food within a package of a predetermined size and shape.

Numbered Paragraph 14: The method of either of Numbered Paragraphs 12 or 13, wherein after the movable wall is moved to the first position, maintaining the movable wall in the first position until the closure has moved to the second position after all pieces of food that established the desired weight have moved into the plenum and have been urged toward the compression chamber.

Numbered Paragraph 15: The method of any one of Numbered Paragraphs 12 to 14, wherein the compression chamber comprises a uniform cross-sectional area from a plane through a head of the piston when the piston is in the second position proximate to the exit aperture of the plenum.

Numbered Paragraph 16: An apparatus for packing a block of compressed food, comprising:
a plenum disposed to intermittently receive a plurality of pieces of food therein, the plenum comprising a movable piston;
a movable closure disposed upon the plenum and with respect to an upper opening into the plenum, wherein the closure is movable between a first position where food is able to move into the plenum through the upper opening and a second position that prevents food from moving into the plenum through the upper opening;
the plenum further comprises a receipt location and a compression chamber, wherein when the closure moves from a first position toward a second position, the pieces of food that fall through the opening are disposed within the receipt location, as the piston moves from the first position toward the second position the piston engages the pieces of food disposed within the receipt location and urges the pieces of food into the compression chamber as the piston moves toward and reaches the second position,
the compression chamber comprises a movable wall at an end thereof, and fixed remaining walls, wherein the movable wall is movable between a pressing position where the movable wall is proximate the remaining walls and a withdrawn position where the movable wall is withdrawn away from the remaining walls, wherein when the movable wall is in the pressing position, the movement of the piston toward and reaching the second position causes the food within the compression chamber to be compressed within a space defined by a front face of the head of the piston, the movable wall and the fixed remaining walls, the plurality of pieces of food are compressed within the compression chamber into a single block of food,
the plenum further comprises an exit aperture that is covered when the movable wall is in the pressing position and exposed when the movable wall is in the withdrawn position,
wherein the space is shaped consistently with a shape of a package that will receive the single block of food, wherein the block of food leaves the plenum through the exit aperture.

Numbered Paragraph 17: The apparatus of Numbered Paragraph 16, wherein the fixed remaining walls of the compression chamber comprise a top wall, a right wall, a left wall, and a bottom wall, wherein the piston is sized with a vertical cross section that is just smaller than a vertical cross-section within the compression chamber defined by the top wall, the right wall, the left wall, and the bottom wall.

Numbered Paragraph 18: The apparatus of either one of Numbered Paragraphs 16 or 17 wherein compression chamber comprises a uniform cross-sectional area along a length of the compression chamber from a plane through a head of the piston when the piston is in the second position proximate to the exit aperture of the plenum.

Numbered Paragraph 19: The apparatus of either one of Numbered Paragraphs 16-18, wherein the compression chamber comprises a top aperture, the food pieces are received within the plenum by falling through the top aperture, the closure in the first position blocks the top aperture, and in the second position exposes the top aperture.

Numbered Paragraph 20: The apparatus of Numbered Paragraph 18, wherein the piston is withdrawn from the plenum when in the first position, and the piston extends through the plenum and across the top aperture as the piston moves toward the compression chamber.

Numbered Paragraph 21: The apparatus of any one of Numbered Paragraphs 16-20, further comprising a scale that receives pieces of food and is configured to intermittently weigh the received food until the weight of the received food equals a desired weight.

1. A method of pressing a plurality of food pieces into a block of compressed food, comprising:
transporting a plurality of pieces of food to a scale and adding pieces of food to the scale until a measured weight of the food results is a desired weight;
facilitating movement, incrementally, the received pieces of food from the scale to a plenum, the plenum includes a movable piston and compression chamber,
upon the movement of a first portion of the food pieces into the plenum, moving a closure to a first position that prevents further movement of pieces of food from the scale to the plenum,
after the closure is moved to the first position that prevents further movement of pieces of food from the scale to the plenum, moving the piston against the pieces of food within the plenum toward the compression chamber;
moving the closure to a second position to allow further movement of pieces of food from the scale to the plenum;
again moving the closure to the first position and again moving the piston against the pieces of food within the plenum toward the compression chamber;
after all pieces of food that established the desired weight have moved into the plenum and have been urged toward the compression chamber, removing the compressed food from the compression chamber.

2. The method of claim 1, wherein the compression chamber comprises fixed top, right, left, and bottom walls, and a movable wall that can be positioned between a first position where the movable wall is adjacent to top, right, left, and bottom walls and a second position where the movable wall is withdrawn from the top, right, left, and bottom walls,
further comprising the step of moving the movable wall to the first position before a first time that the closure is moved to the first position and maintaining the movable wall in the first position until all pieces of food that established the desired weight have been urged toward the compression chamber;
after all pieces of food that established the desired weight have been urged into the compression chamber, moving the movable wall to the second position to allow for the step of removing the compressed food item from the compression chamber, wherein the compressed food is urged through an exit aperture of the compression chamber.

3. The method of claim 1, wherein the plurality of pieces are transported to the scale in a plurality of batches that are transported and weighed in an incremental fashion until the measured weight results in the desired weight.

4. The method of claim 3, wherein the step of facilitating movement incrementally pieces of food from the scale to the plenum comprises rotating a portion of the scale to allow food from the scale to drop into the plenum due to gravity.

5. The method of claim 1, after removing the compressed food item from the compression chamber, packaging the compressed food item within a package of a predetermined size and shape.

6. The method of claim 2, after removing the compressed food from the compression chamber, packaging the compressed food within a package of a predetermined size and shape.

7. The method of claim 2, after the movable wall is moved to the first position, maintaining the movable wall in the first position until the closure has moved to the second position after all pieces of food that established the desired weight have moved into the plenum and have been urged toward the compression chamber.

8. The method of claim 1, wherein the plenum comprises a top aperture, the food pieces are received within the plenum by falling through the top aperture, the closure in the first position blocks the top aperture, and in the second position exposes the top aperture.

9. The method of claim 8, wherein the piston is withdrawn from the plenum when in a first position, and the piston extends through the plenum as the piston moves toward the compression chamber.

10. The method of claim 1, wherein the compression chamber is defined by a planar top wall, a planar right wall, a planar left wall, and a planar bottom wall, wherein the piston includes a head that is sized with a cross section that is just smaller than a cross-section within the compression chamber defined by the planar top wall, the planar right wall, the planar left wall, and the planar bottom wall.

11. The method of claim 1, wherein the compression chamber comprises a uniform cross-sectional area from a plane through a head of the piston when the piston is in the second position proximate to the exit aperture of the plenum.

12. A method of packaging a block of compressed food, comprising:
receiving a plurality of pieces of food;
facilitating movement, incrementally, of the received pieces of food to a plenum, the plenum includes a movable piston and compression chamber,
wherein the compression chamber comprises fixed top, right, left, and bottom walls, and a movable wall that can be positioned between a first position where the movable wall is adjacent to the top, right, left, and bottom walls and a second position where the movable wall is withdrawn from the top, right, left, and bottom walls,
upon the movement of a first portion of the food pieces into the plenum, moving a closure to a first position that prevents further movement of pieces of food into the plenum,
after the closure is moved to the position that prevents further movement of pieces of food into the plenum, moving the piston against the pieces of food within the plenum toward the compression chamber;
moving the movable wall to the first position before a first time that the closure is moved to the first position and maintaining the movable wall in the first position until all pieces of food that established a desired weight have been urged toward the compression chamber;
moving the closure to a second position to allow further movement of pieces to the plenum;
again moving the closure to the first position and again moving the piston against the pieces of food within the plenum toward the compression chamber;
after all pieces of food that established a desired weight have been urged into the compression chamber, moving the movable wall to the second position to allow for the step of removing the compressed food item from the compression chamber and moving the compressed food from an exit aperture in the compression chamber, wherein when the movable wall is in the first position the movable wall blocks movement from the compression chamber through the exit aperture.

13. The method of claim 12, after removing the compressed food from the compression chamber, further comprising packaging the compressed food within a package of a predetermined size and shape.

14. The method of claim 12, wherein after the movable wall is moved to the first position, maintaining the movable wall in the first position until the closure has moved to the second position after all pieces of food that established the desired weight have moved into the plenum and have been urged toward the compression chamber.

15. The method of claim 12, wherein the compression chamber comprises a uniform cross-sectional area from a plane through a head of the piston when the piston is in the second position proximate to the exit aperture of the plenum.

16. An apparatus for packing a block of compressed food, comprising:
a plenum disposed to intermittently receive a plurality of pieces of food therein, the plenum comprising a movable piston;
a movable closure disposed upon the plenum and with respect to an upper opening into the plenum, wherein the closure is movable between a first position where food is able to move into the plenum through the upper opening and a second position that prevents food from moving into the plenum through the upper opening;
the plenum further comprises a receipt location and a compression chamber, wherein when the closure moves from a first position toward a second position, the pieces of food that fall through the opening are disposed within the receipt location, as the piston moves from the first position toward the second position the piston engages the pieces of food disposed within the receipt location and urges the pieces of food into the compression chamber as the piston moves toward and reaches the second position,
the compression chamber comprises a movable wall at an end thereof, and fixed remaining walls, wherein the movable wall is movable between a pressing position where the movable wall is proximate the remaining walls and a withdrawn position where the movable wall is withdrawn away from the remaining walls, wherein when the movable wall is in the pressing position, the movement of the piston toward and reaching the second position causes the food within the compression chamber to be compressed within a space defined by a front face of the head of the piston, the movable wall and the fixed remaining walls, the plurality of pieces of food are compressed within the compression chamber into a single block of food,
the plenum further comprises an exit aperture that is covered when the movable wall is in the pressing position and exposed when the movable wall is in the withdrawn position,
wherein the space is shaped consistently with a shape of a package that will receive the single block of food, wherein the block of food leaves the plenum through the exit aperture.

17. The apparatus of claim 16, wherein the fixed remaining walls of the compression chamber comprise a top wall, a right wall, a left wall, and a bottom wall, wherein the piston is sized with a vertical cross section that is just smaller than a vertical cross-section within the compression chamber defined by the top wall, the right wall, the left wall, and the bottom wall.

18. The apparatus of claim 16 wherein compression chamber comprises a uniform cross-sectional area along a length of the compression chamber from a plane through a head of the piston when the piston is in the second position proximate to the exit aperture of the plenum.

19. The apparatus of claim 16, wherein the plenum comprises a top aperture, the food pieces are received within the plenum by falling through the top aperture, the closure in the first position blocks the top aperture, and in the second position exposes the top aperture.

20. The apparatus of claim 18, wherein the piston is withdrawn from the plenum when in the first position, and the piston extends through the plenum and across the top aperture as the piston moves toward the compression chamber.

21. The apparatus of claim 16, further comprising a scale that receives pieces of food and is configured to intermittently weigh the received food until the weight of the received food equals a desired weight.
